(19) United States
(12) Patent Application Publication
(10) Pub. No.: US 2020/0130764 A1
(43) Pub. Date: Apr. 30, 2020

(54) BICYCLE RACK ASSEMBLY FOR A SUSPENSION FORK

(71) Applicant: Trek Bicycle Corporation, Waterloo, WI (US)

(72) Inventor: Randy Phillips, Monona, WI (US)

(21) Appl. No.: 16/176,050

(22) Filed: Oct. 31, 2018

(51) Int. Cl. B62J 9/00

(52) U.S. Cl. CPC B62J 9/001

(57) ABSTRACT

A rack for a bicycle includes a first arm and a second arm. A first mount is attached to the first arm and configured to secure the first arm to a first blade of a bicycle fork. A second mount is attached to the second arm and configured to secure the second arm to a second blade of the bicycle fork. The rack also includes a bridge mount configured to rest upon a fork bridge of the bicycle fork. The rack further includes a first accessory plate mounted to the first arm, where the first accessory plate is configured to receive an accessory cage.

### BACKGROUND

A bicycle rack is a component that mounts to a bicycle and is used to carry/store items on the bicycle. For example, some bicycle racks form a cylindrical opening (or cage) and are used to support a bottle that contains water or another beverage. Other bicycle racks are flat and include tie down areas so that various items can be secured to the rack. Other bicycle racks are in the form of a basket, bag, or other receptacle in which items can be placed. Bicycle racks are often mounted to a handlebar unit of the bicycle, a fender of the bicycle, or a portion of a frame of the bicycle such as a down tube. Cyclists use bicycle racks for a variety of purposes, including carrying food/water, camping gear, extra clothes, bicycle parts and tools, etc.

### SUMMARY

An illustrative rack for a bicycle includes a first arm and a second arm. A first mount is attached to the first arm and configured to secure the first arm to a first blade of a bicycle fork. A second mount is attached to the second arm and configured to secure the second arm to a second blade of the bicycle fork. The rack also includes a bridge mount configured to rest upon a fork bridge of the bicycle fork. The rack further includes a first accessory plate mounted to the first arm, where the first accessory plate is configured to receive an accessory cage.

An illustrative method of forming a bicycle rack to a bicycle includes forming a first arm of the bicycle rack to at least partially match a contour of a first blade of a bicycle fork. The method also includes forming a second arm of the bicycle rack to at least partially match a contour of a second blade of the bicycle fork. The method also includes attaching a first mount to the first arm, where the first mount is used to secure the first arm to the first blade of the bicycle fork. The method also includes attaching a second mount to the second arm, where the second mount is used to secure the second arm to the second blade of the bicycle fork. The method further includes connecting the first arm and the second arm with a bridge mount. The bridge mount is configured to attach to a fork bridge of the bicycle fork such that the fork bridge bears a load imposed by the bicycle rack.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a bicycle to which a rack system can be mounted in accordance with an illustrative embodiment.

FIG. 2A is a front perspective view of a bicycle rack in accordance with an illustrative embodiment.

FIG. 2B is a rear perspective view of the bicycle rack shown in FIG. 2A in accordance with an illustrative embodiment.

FIG. 3 is a partial side view of a bridge mount and a fender of the bicycle rack in accordance with an illustrative embodiment.

FIG. 4 depicts the bicycle rack mounted to a front suspension fork in accordance with an illustrative embodiment.

FIG. 5 is a partial side view of the interface between the bicycle rack and the front suspension fork in accordance with an illustrative embodiment.

FIG. 6 depicts a pair of accessory cages mounted to the bicycle rack in accordance with an illustrative embodiment.

FIG. 7 depicts two pairs of accessory cages mounted to the bicycle rack in accordance with an illustrative embodiment.

### DETAILED DESCRIPTION

Described herein is a bicycle rack system configured to mount to a bicycle fork, such as a suspension fork. A front bicycle fork is a portion of the bicycle that connects a steering system of the bicycle to a wheel of the bicycle. The bicycle fork includes a pair of spaced apart blades, and the bicycle wheel is positioned in between the blades. A lower end of the blades includes an opening or slot that mounts to a central hub of the wheel. At their upper end, the blades join together to form a crown. A steerer tube of the bicycle mounts to the crown such that a rider is able to steer the wheel of the bicycle using a handlebar (which is mounted to the steerer tube). A suspension fork includes spring and damper components in each blade that compress and decompress as a bicycle is ridden over bumps, etc. Also, in addition to a crown, a suspension fork also includes a fork bridge that typically connects the external sliders of the blades of the fork and helps to ensure that the blades compress/decompress in unison. The suspension fork is used to provide a smoother ride by dampening the effects of riding over rough terrain.

The bicycle rack system described herein can be used on any type of bicycle that utilizes a suspension fork. In an illustrative embodiment, the bicycle rack system is adaptable for use with a variety of different bicycle forks. For example, in one embodiment, the bicycle rack system is universal for forks that are between 27.5 inches and 29 inches. In alternative embodiments, the bicycle rack system can be used on forks that are shorter than 27.5 inches or longer that 29 inches. The embodiments described herein are with reference to mounting the bicycle rack system on a front fork. In alternative embodiments, the bicycle rack system can be used with a rear suspension system for a bicycle as well.

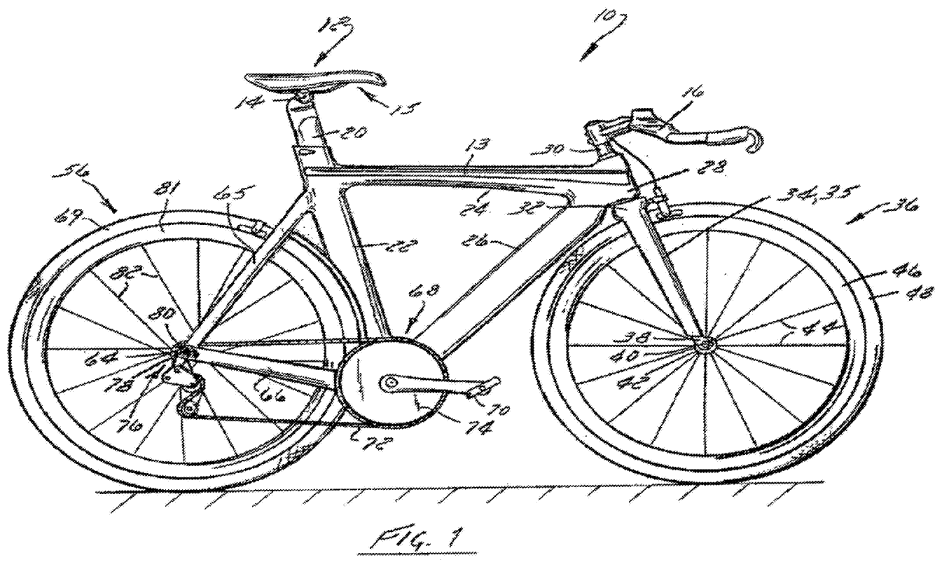

FIG. 1 depicts a bicycle 10 to which a rack system can be mounted in accordance with an illustrative embodiment. The bicycle 10 includes a frame 13 to which a seat assembly 12 and handlebars 16 are attached. A seat clamp 14 is engaged with an underside 15 of seat assembly 12 and cooperates with a seat post 20 that slidably engages a seat tube 22 of frame 13. A top tube 24 and a down tube 26 extend forwardly from seat tube 22 to a head tube 28 of frame 13.

Handlebars 16 are connected to a steerer tube 30 that passes through head tube 28 and engages a fork crown 32. A pair of fork blades 34, 35 extend from generally opposite ends of fork crown 32 and are constructed to support a front wheel assembly 36 at an end thereof or fork tip 38. The fork blades 34, 35 can be part of a suspension bicycle fork or a rigid bicycle fork. The bicycle rack systems described herein can be mounted to the fork blades 34, 35 using any of the techniques described below. As also shown in FIG. 1, fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42.

A rear wheel assembly 56 is positioned generally concentrically about a rear axle 64. A seat stay 65 and a chain stay 66 offset rear axle 64 from a crankset 68. The crankset 68 includes pedals 70 that are operationally connected to a flexible drive such as a chain 72 via a chain ring or sprocket 74. Rotation of the chain 72 communicates a drive force to a rear section 76 of the bicycle 10 having a gear cluster 78 positioned thereat. The gear cluster 78 is generally concentrically orientated with respect to the rear axle 64 and includes a number of variable diameter gears. The gear cluster 78 is operationally connected to a hub 80 associated with a rear tire 69 of rear wheel assembly 56. A number of spokes 82 extend radially between the hub 80 and a rim 81 that supports tire 69 of rear wheel assembly 56. As is commonly understood, rider operation of the pedals 70 drives the chain 72 thereby driving the rear tire 69 which in turn propels the bicycle 10.

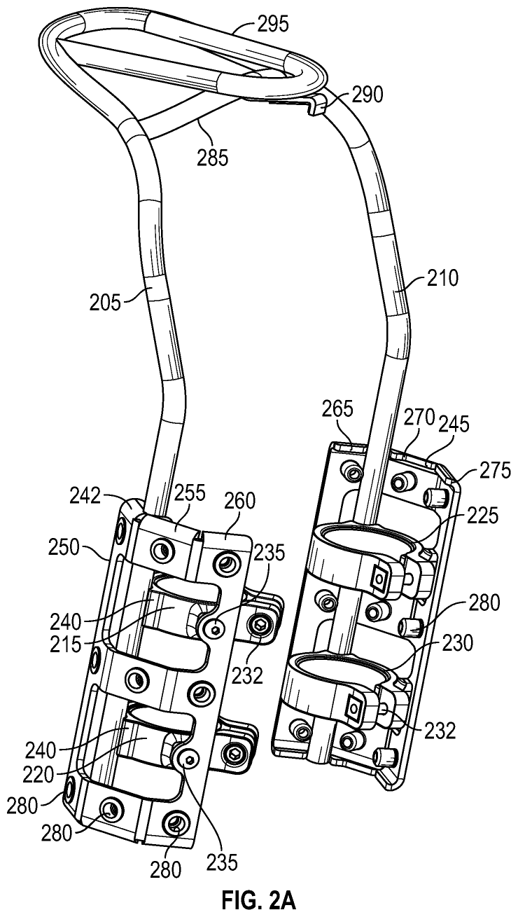

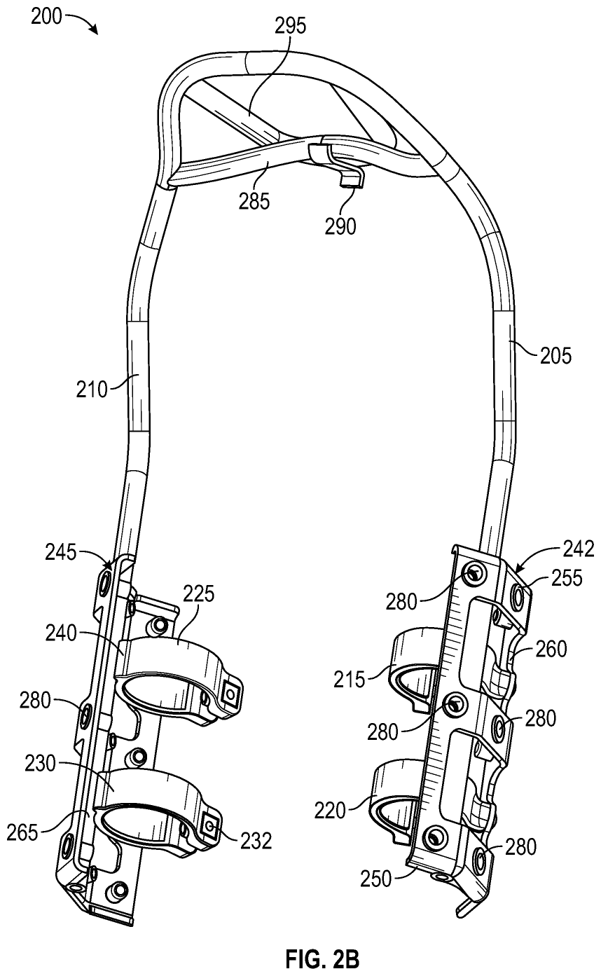

FIG. 2A is a front perspective view of a bicycle rack 200 in accordance with an illustrative embodiment. FIG. 2B is a rear perspective view of the bicycle rack 200 in accordance with an illustrative embodiment. Components of the bicycle rack 200 can be made of carbon fiber, aluminum, stainless steel, plastic, etc., depending on the application. The bicycle rack 200 includes a first arm 205 that is positioned adjacent to a first blade of a bicycle fork when the bicycle rack 200 is mounted to the bicycle fork. The bicycle rack also includes a second arm 210 that is positioned adjacent to a second blade of the bicycle fork when the bicycle rack 200 is mounted thereto. In an illustrative embodiment, a shape/contour of the first arm 205 and the second arm 210 are configured to at least partially match the shape/contour of the first and second blades adjacent to which they are mounted.

Mounted to the first arm 205 are blade mounts 215 and 220 that are configured to attach to the first blade of the bicycle fork. Similarly, mounted to the second arm 210 are blade mounts 225 and 230 that are configured to attach to the second blade of the bicycle fork. Each of the blade mounts 215, 220, 225, 230 is in the form of a clamp that includes an adjustable opening that is configured to receive a portion of a blade. Each of the blade mounts 215, 220, 225, 230 also includes a fastener 232 that is used to adjust a size of the opening such that the blade mounts can be tightened around the bicycle forks by tightening the fastener and loosened from the bicycle forks by loosening the fastener. The blade mounts can be mounted to the bicycle rack 200 via fasteners 235 as shown in FIG. 1A. Additionally, each of the blade mounts includes a slot 240 that is configured to receive an arm to which it is mounted. In alternative embodiments, a weld, solder, adhesive, or other connection can be used to attach the blade mounts to the arms of the bicycle rack.

In one embodiment, the blade mounts are positioned on the blades of the bicycle fork by removing the bicycle tire, aligning the blade mounts 215 and 220 with the first blade of the fork, aligning the blade mounts 225 and 230 with the second blade of the fork, and sliding the bicycle rack 200 onto the blades of the fork such that the first and second bicycle forks are received by the openings in the blade mounts. In an alternative embodiment, each of the blade mounts can include a hinge or other flexible portion that allows the blade mount to open up and receive a blade. Once the blade is positioned within the blade mount, the blade mount is closed and secured to the blade by tightening the fastener 232.

In other alternative embodiments, a different type of mount may be used to connect the bicycle rack 200 to the blades of the bicycle fork. For example, in one embodiment, a hose clamp style of mount may be used in which tightening/loosing of a fastener causes the clamp to ratchet and become more tightly/loosely fitted around the blade. In another embodiment, a fastener can be positioned through or around the arms of the bicycle rack 200 and into a threaded opening in the blade such that the arms are directly mounted to the blades.

As depicted in FIGS. 2A and 2B, an accessory plate 242 is mounted to the first arm 205 and an accessory plate 245 is mounted to the second arm 210. The accessory plate 242 includes three mounting surfaces 250, 255, and 260, and the accessory plate 245 includes three mounting surfaces 265, 270, and 275. The mounting surfaces are used to receive accessories and/or accessory mounts such as cages. In one embodiment, each of the mounting surfaces is configured to receive a separate accessory or accessory mount. Alternatively, a single accessory or accessory mount can be mounted to a plurality of the mounting surfaces. In another alternative embodiment, the accessory plates can include fewer or additional mounting surfaces, such as 1, 2, 4, etc.

As depicted, the mounting surfaces that form each of the accessory plates 242, 245 are positioned at an angle relative to one another. The angle between mounting surfaces can vary depending on the embodiment. In one embodiment, the mounting surfaces can be connected to one another with hinges or another flexible member such that the angle formed between adjacent mounting surfaces is adjustable.

Each of the mounting surfaces includes three threaded inserts 280 which are configured to receive fasteners such that accessories or accessory mounts can be mounted to the bicycle rack 200. In an illustrative embodiment, the threaded inserts 280 are vertically spaced 64 millimeters (mm) apart from one another. Alternatively, any other spacing between inserts may be used, such as 30 mm, 40, mm, 50 mm, 70 mm, 90 mm, etc. In another alternative embodiment, instead of threaded inserts, the accessory plates can include threaded holes, unthreaded holes, slots, etc. Additionally, the accessory plates can include fewer or additional threaded inserts (or other openings), such as 1, 2, 4, 5, etc.

The bicycle rack 200 also includes a bridge mount 285 that is mounted to and extends between the first arm 205 and the second arm 210. The bridge mount 285 includes a clip 290 that is used to secure the bicycle rack 200 to a bridge of a bicycle fork. Specifically, the clip 290 includes a flange that rests on a rear side of the fork bridge to help keep the bicycle rack 200 in place. In an alternative embodiment, the clip 290 may not be included, and the bridge mount 285 can be configured to just rest upon the fork bridge. In another alternative embodiment, a different type of securing mechanism can be used to secure the bridge mount 285 to the bridge, such as one or more fasteners, a male/female connection, an adhesive, a weld, etc. In an illustrative embodiment, the bridge mount 285 rests on the bridge such that the bridge is the main support for the load of the bicycle rack 200 and any accessories and/or accessory cages mounted thereto. In this way, the blade mounts 215, 220, 225, 230 support little or no load, and are used primarily to prevent rotation of the bicycle rack 200 on the bicycle fork. This configuration reduces the amount of stress imposed on the blades of the fork.

The bicycle rack 200 further includes a fender 295 that is used to help support a bag, basket, rack, etc. mounted to a handlebar of the bicycle. The fender 295 limits the amount of stress placed on the handlebar. The fender 295 also helps to keep items mounted to the handlebar from coming into contact with the tire of the bicycle. As depicted, the fender 295 is a u-shaped element that extends from the first arm 205 and the second arm 210. Alternatively, the fender 295 can have a different shape such as circular, square, triangular, rectangular, etc. Additionally, the fender 295 can be partially or entirely mounted to the bridge mount 285. Also, the clip 290 used to secure the bicycle rack 200 to the fork bridge can be partially or entirely mounted to the fender 295 in an alternative embodiment. In another alternative embodiment, the fender 295 may be omitted from the bicycle rack 200.

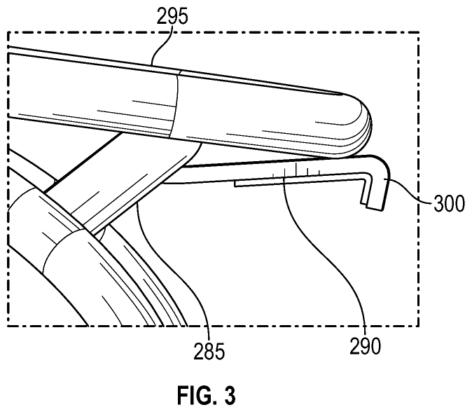

FIG. 3 is a partial side view of the bridge mount 285 and the fender 295 in accordance with an illustrative embodiment. As shown, the clip 290 is mounted to the bridge mount 285 and includes a flange 300 that rests on a rear side of the fork bridge to help secure the bicycle rack 200 to the fork bridge. In an illustrative embodiment, the clip 290 is an integral component of the bridge mount 285. Alternatively, the clip 290 can be mounted to the bridge mount 285 (and/or to the fender 295) via a fastener or another type of connection.

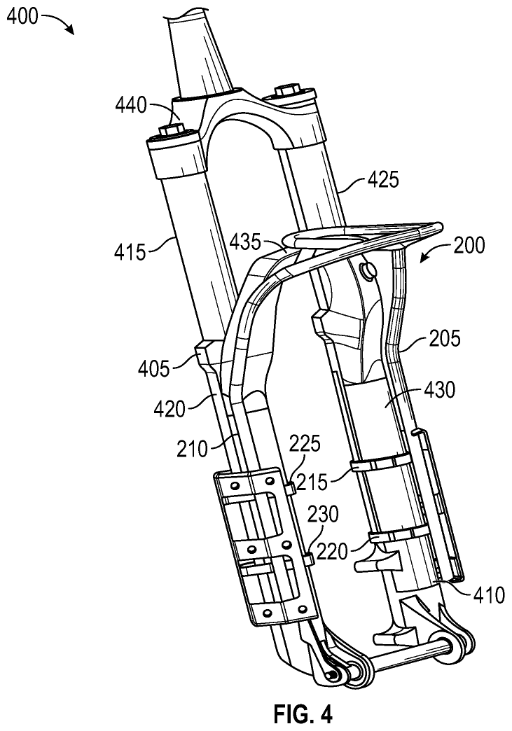

FIG. 4 depicts the bicycle rack 200 mounted to a front suspension fork 400 in accordance with an illustrative embodiment. The front suspension fork 400 includes a first blade 405 and a second blade 410. The first blade 405 includes an internal slider 415 and an external slider 420, and the second blade 410 similarly includes an internal slider 425 and an external slider 430. The slider configuration allows the front suspension fork 400 to compress and decompress such that shocks are absorbed as the bicycle is ridden. The front suspension fork 400 also includes a bridge 435 that connects the external slider 420 and the external slider 430. A crown 440 of the front suspension fork 400 joins the internal slider 415 and the internal slider 425.

The blade mounts 215 and 220 are used to secure the first arm 205 of the bicycle rack 200 to the external slider 430 of the second blade 410, and the blade mounts 225 and 230 are used to secure the second arm 210 to the external slider 420 of the first blade 405. As discussed above, a primary purpose of the blade mounts 215, 220, 225, and 230 is to help prevent the bicycle rack 200 from rotating or twisting relative to the front suspension fork 400 when mounted. The primary load bearing portion of the bicycle rack 200 is the bridge mount 285, which is mounted to the bridge 435 of the front suspension fork 400. This interface allows the load imposed on the bicycle rack 200 to be transferred to the front suspension fork 400 via the bridge 435.

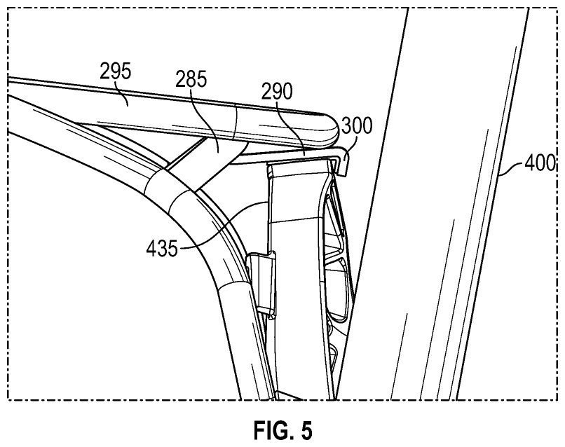

FIG. 5 is a partial side view of the interface between the bicycle rack 200 and the front suspension fork 400 in accordance with an illustrative embodiment. As shown, the clip 290 of the of the bridge mount 285 rests upon an upper surface of the bridge 435 of the front suspension fork 400. Additionally, a portion of the fender 295 rests upon the clip 290 such that any load imposed upon the fender 295 is also transferred to the bridge 435 of the front suspension fork 400. The flange 300 of the clip 290 is positioned on a rear side of the bridge 435 and is used to secure the bicycle rack 200 to the front suspension fork 400.

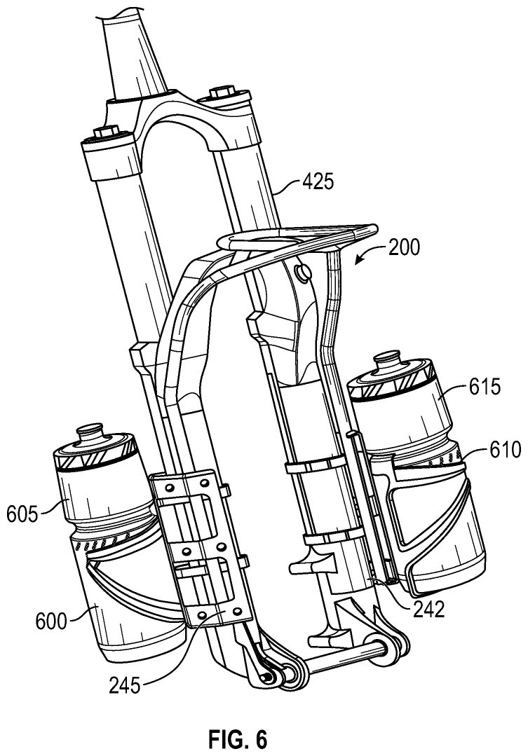

FIG. 6 depicts a pair of accessory cages mounted to the bicycle rack 200 in accordance with an illustrative embodiment. A first accessory cage 600 is mounted to the accessory plate 245 of the first arm 205 of the bicycle rack 200. The first accessory cage 600 holds a beverage container 605. The first accessory cage 600 is mounted to the mounting surface 270 of the accessory plate 245. Specifically, fasteners are used to mount the first accessory cage 600 to the threaded inserts 280 of the mounting surface 270. Alternatively, the first accessory cage 600 could be mounted to the mounting surface 265 or the mounting surface 275 of the accessory plate 245.

Similarly, a second accessory cage 610 is mounted to the accessory plate 242 of the second arm 210, and the second accessory cage 600 holds a beverage container 615. The second accessory cage 610 is mounted to the mounting surface 255 of the accessory plate 242. Specifically, fasteners are used to mount the second accessory cage 610 to the threaded inserts 280 of the mounting surface 255. Alternatively, the second accessory cage 610 could be mounted to the mounting surface 250 or the mounting surface 260 of the accessory plate 242.

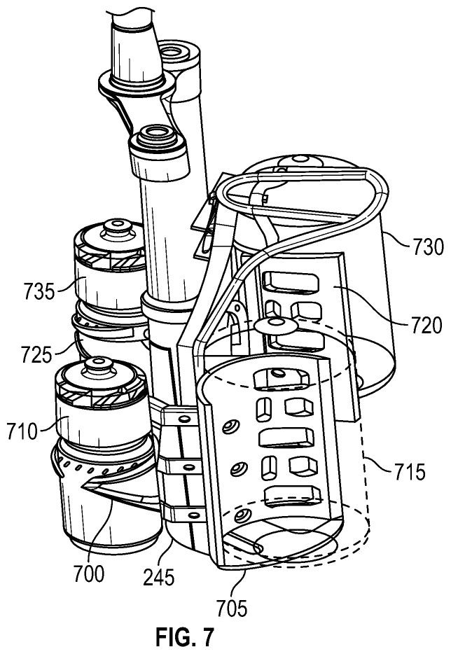

FIG. 7 depicts two pairs of accessory cages mounted to the bicycle rack 200 in accordance with an illustrative embodiment. A first accessory cage 700 and a second accessory cage 705 are both mounted to the accessory plate 245. Specifically, the first accessory cage 700 is mounted to threaded inserts 280 on the mounting surface 275 of the accessory plate 245 and the second accessory cage 705 is mounted to threaded inserts 280 on the mounting surface 265 of the accessory plate 245. A beverage container 710 is held within the first accessory cage 700 and a container 715 is held within the second accessory cage 705. The container 715 can be another beverage container, a tool container, a food container, a general storage receptacle, etc.

As also shown in FIG. 7, a third accessory cage 720 and a fourth accessory cage 725 are both mounted to the accessory plate 242. Specifically, the third accessory cage 720 is mounted to threaded inserts 280 on the mounting surface 250 of the accessory plate 242 and the fourth accessory cage 725 is mounted to threaded inserts 280 on the mounting surface 260 of the accessory plate 242. A container 730 is held within the third accessory cage 720 and a beverage container 735 is held within the fourth accessory cage 725.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A rack for a bicycle, comprising:
a first arm and a second arm;
a first mount attached to the first arm and configured to secure the first arm to a first blade of a bicycle fork;
a second mount attached to the second arm and configured to secure the second arm to a second blade of the bicycle fork;
a bridge mount configured to rest upon a fork bridge of the bicycle fork; and
a first accessory plate mounted to the first arm, wherein the first accessory plate is configured to receive an accessory cage.

2. The rack of claim 1, wherein the bridge mount is connected to the first arm and the second arm.

3. The rack of claim 1, wherein the bridge mount includes a clip that secures the bridge mount to the fork bridge.

4. The rack of claim 3, wherein the clip includes a flange that engages a rear portion of the fork bridge.

5. The rack of claim 1, wherein the first accessory plate includes a plurality of mounting surfaces, and wherein each of the plurality of mounting surfaces is configured to receive the accessory cage.

6. The rack of claim 5, wherein each of the plurality of mounting surfaces includes a plurality of openings for mounting the accessory cage.

7. The rack of claim 6, wherein the plurality of openings comprise threaded inserts.

8. The rack of claim 5, wherein the plurality of mounting surfaces are positioned at an angle relative to one another.

9. The rack of claim 1, wherein the first arm is contoured to match a shape of the first blade.

10. The rack of claim 1, further comprising a fender mounted to the first arm and the second arm, where the fender is configured to prevent contact between a tire of the bicycle and an item mounted to a handlebar of the bicycle.

11. The rack of claim 1, wherein the first mount comprises a clamp, and wherein the clamp includes a fastener that is used to tighten and loosen the clamp.

12. The rack of claim 1, wherein the first mount comprises a pair of clamps.

13. The rack of claim 1, wherein the first mount includes a slot that is configured to receive the first arm such that the first mount is secured to the first arm.

14. The rack of claim 1, further comprising one or more fasteners to secure the first mount to the first accessory plate.

15. The rack of claim 1, further comprising a second accessory plate mounted to the second arm, wherein the second accessory plate is also configured to receive the accessory cage.

16. A method of forming a bicycle rack to a bicycle, the method comprising:
forming a first arm of the bicycle rack to at least partially match a contour of a first blade of a bicycle fork;
forming a second arm of the bicycle rack to at least partially match a contour of a second blade of the bicycle fork;
attaching a first mount to the first arm, wherein the first mount is used to secure the first arm to the first blade of the bicycle fork;
attaching a second mount to the second arm, wherein the second mount is used to secure the second arm to the second blade of the bicycle fork; and
connecting the first arm and the second arm with a bridge mount, wherein the bridge mount is configured to attach to a fork bridge of the bicycle fork such that the fork bridge bears a load imposed by the bicycle rack.

17. The method of claim 16, further comprising mounting an accessory plate to the first arm, wherein the accessory plate is configured to receive an accessory cage.

18. The method of claim 17, further comprising forming the first accessory plate to include a plurality of mounting surfaces, wherein each of the plurality of mounting surfaces is configured to receive the accessory cage.

19. The method of claim 16, further comprising attaching a clip to the bridge mount, wherein the clip includes a flange that is configured to rest upon a rear portion of the fork bridge.

20. The method of claim 16, further comprising attaching a fender to the first arm and the second arm, where the fender is configured to prevent contact between a tire of the bicycle and an item mounted to a handlebar of the bicycle.
